(19) United States
(12) Patent Application Publication
(10) Pub. No.: US 2023/0298461 A1
(43) Pub. Date: Sep. 21, 2023

(54) APPARATUS FOR PREDICTING CONGESTION TIME POINT AND METHOD THEREOF

(71) Applicants: Hyundai Motor Company, Seoul (KR); Kia Corporation, Seoul (KR)

(72) Inventor: Nam Hyuk KIM, Seoul (KR)

(73) Assignees: Hyundai Motor Company, Seoul (KR); Kia Corporation, Seoul (KR)

(21) Appl. No.: 17/895,901

(22) Filed: Aug. 25, 2022

(30) Foreign Application Priority Data
Mar. 15, 2022 (KR) 10-2022-0032311

(51) Int. Cl. G08G 1/01

(52) U.S. Cl. CPC G08G 1/0133

(57) ABSTRACT

An apparatus of predicting the congestion time point may include a first deep learning device that outputs first output data using traffic speed data during a first time, a second deep learning device that outputs second output data using traffic volume data during a second time, and a congestion time point prediction model that predicts the congestion time point using at least a portion of the first output data and the second output data.

### CROSS-REFERENCE TO RELATED APPLICATION

The present application claims priority to Korean Patent Application No. 10-2022-0032311, filed on Mar. 15, 2022, the entire contents of which is incorporated herein for all purposes by this reference.

### BACKGROUND OF THE PRESENT DISCLOSURE

### Field of the Present Disclosure

The present disclosure relates to an apparatus of predicting a congestion time point and a method thereof, and more particularly, relates to an apparatus of predicting a congestion time point to predict a traffic speed during a specified time in the future using traffic speed data and/or traffic volume data, based on a plurality of deep learning devices and a prediction model, and predict the congestion time point based on the predicted result and a method thereof.

### Description of Related Art

A prediction device according to an existing technology may predict a traffic speed during a specified time in the future using traffic speed data during a specified time in the past. For example, the prediction device may perform future prediction using past data by deep learning.

In general, the deep learning is a kind of machine learning, which refers to an artificial neural network (ANN) including multiple hidden layers between an input layer and an output layer.

The existing technology for predicting a traffic speed based on the deep learning performs supervised learning of a model based on learning data composed of a pair of input data and output data (right answer data) and predicts a traffic speed in the future using the model, the supervised learning of which is completed.

Because such an existing technology performs only statistical prediction using only a past traffic speed, the trend of traffic speed becomes different from the past or a change in external factor except for the traffic speed is not reflected.

The prediction device according to the existing technology does not consider traffic volume on a corresponding road where the vehicle is currently traveling and/or traffic volume on a forward road expected that the vehicle will travel in the future at all to predict a traffic speed in the future and rapidly decrease prediction performance of a start time point expected that congestion will occur and a resolve time point expected that the congestion will be resolved.

Thus, there is a need to develop a technology for predicting a congestion time point by further considering various parameters rather than only the traffic speed to more accurately predict a possibility of congestion or a congestion time point.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus of predicting a congestion time point to predict a traffic speed in the future by receiving a past traffic speed and past traffic volume and predicting the congestion time point based on the predicted traffic speed in the future.

The purposes of the present disclosure are not limited to the aforementioned purposes, and any other purposes and advantages not mentioned herein will be clearly understood from the following description and may more clearly known by an exemplary embodiment of the present disclosure. Furthermore, it may be easily seen that purposes and advantages of the present disclosure may be implemented by means indicated in claims and a combination thereof.

According to an aspect of the present disclosure, an apparatus of predicting a congestion time point may include a first deep learning device that outputs first output data using traffic speed data during a first time, a second deep learning device that outputs second output data using traffic volume data during a second time, and a congestion time point prediction model that predicts the congestion time point using at least a portion of the first output data and the second output data.

In an exemplary embodiment of the present disclosure, the congestion time point prediction model may obtain input data determined by performing concatenate calculation of the first output data and the second output data and may predict the congestion time point using the input data.

In an exemplary embodiment of the present disclosure, the congestion time point prediction model may predict a traffic speed up to a specified time in the future using the input data and may predict the congestion time point using the predicted traffic speed.

In an exemplary embodiment of the present disclosure, the first time and the second time may correspond to a same past time.

In an exemplary embodiment of the present disclosure, the congestion time point prediction model may update a weight included in the congestion time point prediction model so that a mean squared error (MSE) is reduced, using the predicted traffic speed.

In an exemplary embodiment of the present disclosure, the congestion time point prediction model may identify a first time point when a traffic speed decreases to reach a congestion state in the first time and a second time point when a traffic volume reaches a saturation state in the second time, may identify a correlation between the first time point and the second time point, and may predict the congestion time point using the identified correlation.

In an exemplary embodiment of the present disclosure, the congestion time point prediction model may identify traffic volume on a forward road and traffic volume on a corresponding road, wherein the traffic volume on the forward road and the traffic volume on the corresponding road are included in the second output data and may predict the congestion time point by further using whether each of the identified traffic volume on the forward road and the identified traffic volume on the corresponding road is saturated or is increased or decreased.

In an exemplary embodiment of the present disclosure, the congestion time point prediction model may identify a first traffic speed at a first time point when a traffic speed decreases to reach a congestion state in the first time and may predict that congestion will not occur, when a current traffic speed is substantially the same as the first traffic speed and when current traffic volume on the corresponding road does not reach a saturation state.

In an exemplary embodiment of the present disclosure, the congestion time point prediction model may identify first traffic volume at a second time point when the traffic volume on the corresponding road reaches a saturation state in the second time and may predict that congestion will be resolved, when it is identified that current traffic volume is substantially the same as the first traffic volume and will gradually decrease in the future.

In an exemplary embodiment of the present disclosure, the congestion time point prediction model may divide the first output data and the second output data into a train set and a test set and may perform cross validation, using the train set and the test set.

In an exemplary embodiment of the present disclosure, the congestion time point prediction model may determine accuracy by use of at least a portion of the train set as a validation set and may perform an early stopping function in an epoch identified as including accuracy of a predetermined value or more the predetermined value.

According to another aspect of the present disclosure, a method for predicting a congestion time may include outputting, by a first deep learning device, first output data using traffic speed data during a first time, outputting, by a second deep learning device, second output data using traffic volume data during a second time, and predicting, by a congestion time point prediction model, the congestion time point using at least a portion of the first output data and the second output data.

In an exemplary embodiment of the present disclosure, the predicting of the congestion time point by the congestion time point prediction model may include obtaining input data determined by performing concatenate calculation of the first output data and the second output data and predicting the congestion time point using the input data.

In an exemplary embodiment of the present disclosure, the predicting of the congestion time point by the congestion time point prediction model may include predicting a traffic speed up to a specified time in the future using the input data and predicting the congestion time point using the predicted traffic speed.

In an exemplary embodiment of the present disclosure, the method may further include updating a weight included in the congestion time point prediction model so that a mean squared error (MSE) is reduced, using the predicted traffic speed.

In an exemplary embodiment of the present disclosure, the predicting of the congestion time point by the congestion time point prediction model may include identifying a first time point when a traffic speed decreases to reach a congestion state in the first time and a second time point when a traffic volume reaches a saturation state in the second time, identifying a correlation between the first time point and the second time point, and predicting the congestion time point using the identified correlation.

In an exemplary embodiment of the present disclosure, the predicting of the congestion time point by the congestion time point prediction model may include identifying traffic volume on a forward road and traffic volume on a corresponding road, wherein the traffic volume on the forward road and the traffic volume on the corresponding road are included in the second output data and predicting the congestion time point by further using whether each of the identified traffic volume on the forward road and the identified traffic volume on the corresponding road is saturated or is increased or decreased.

In an exemplary embodiment of the present disclosure, the predicting of the congestion time point by the congestion time point prediction model may include identifying a first traffic speed at a first time point when a traffic speed decreases to reach a congestion state in the first time and predicting that congestion will not occur, when a current traffic speed is substantially the same as the first traffic speed and when current traffic volume on the corresponding road does not reach a saturation state.

In an exemplary embodiment of the present disclosure, the predicting of the congestion time point by the congestion time point prediction model may include identifying first traffic volume at a second time point when the traffic volume on the corresponding road reaches the saturation state in the second time and predicting that the congestion will be resolved, when it is identified that current traffic volume is substantially the same as the first traffic volume and will gradually decrease in the future.

In an exemplary embodiment of the present disclosure, the method may further include dividing the first output data and the second output data into a train set and a test set and performing cross validation, using the train set and the test set.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates components included in an apparatus of predicting a congestion time point according to an exemplary embodiment of the present disclosure;

FIG. 2 illustrates components included in an apparatus of predicting a congestion time point according to an exemplary embodiment of the present disclosure;

FIG. 3 is a drawing illustrating a relationship among a real-time speed, a pattern speed, and traffic volume according to an exemplary embodiment of the present disclosure;

FIG. 4A is a drawing illustrating a relationship between traffic volume and a real-time speed according to an exemplary embodiment of the present disclosure;

FIG. 4B is a drawing illustrating a relationship between traffic volume and a real-time speed according to an exemplary embodiment of the present disclosure;

FIG. 4C is a drawing illustrating a relationship between traffic volume and a real-time speed according to an exemplary embodiment of the present disclosure;

FIG. 5 is a drawing illustrating a relationship between traffic volume and a real-time speed according to an exemplary embodiment of the present disclosure;

FIG. 6 is an operational flowchart of an apparatus of predicting a congestion time point according to an exemplary embodiment of the present disclosure;

FIG. 7 illustrates an example of a relationship among traffic volume, whether an accident occurs, and congestion occurs and a predicted result of an apparatus of predicting a congestion time point according to an exemplary embodiment of the present disclosure; and

FIG. 8 is a block diagram illustrating a computing system according to an exemplary embodiment of the present disclosure.

It may be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding the reference numerals to the components of each drawing, it should be noted that the identical component is designated by the identical numerals even when they are displayed on other drawings. Furthermore, in describing the exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”, “B”, (a), (b), and the like may be used. These terms are merely intended to distinguish one component from another component, and the terms do not limit the nature, sequence or order of the corresponding components. Furthermore, unless otherwise defined, all terms including technical and scientific terms used herein are to be interpreted as is customary in the art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

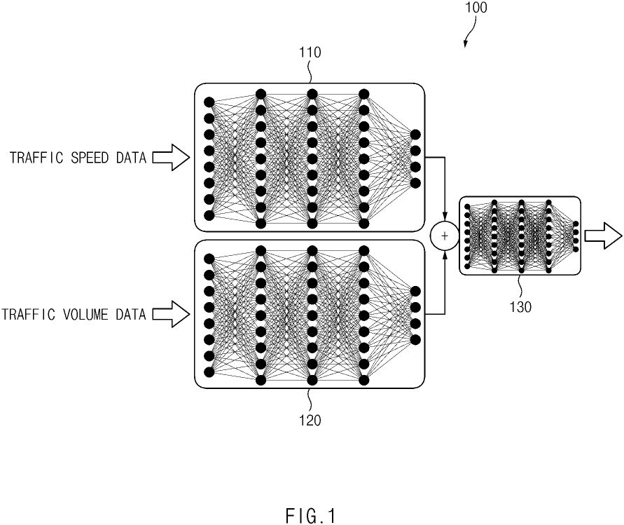

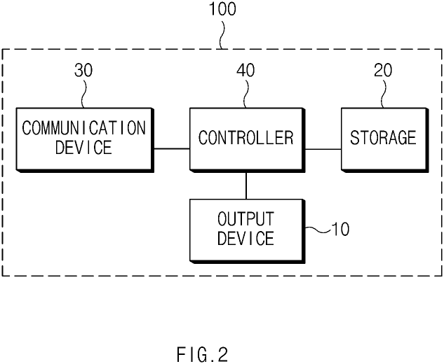

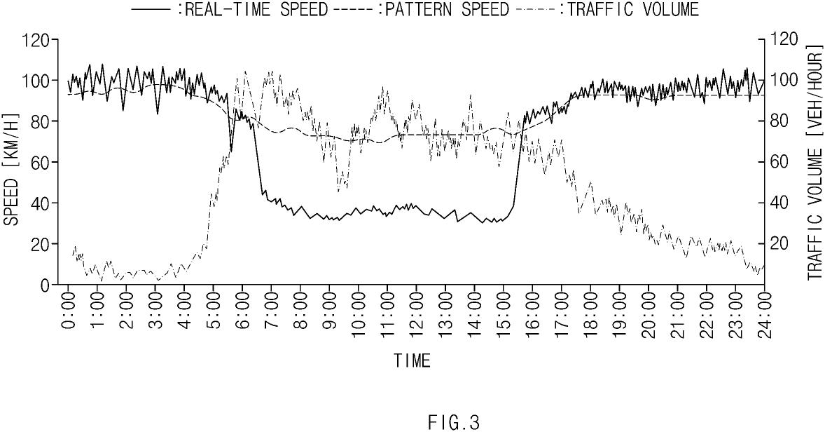

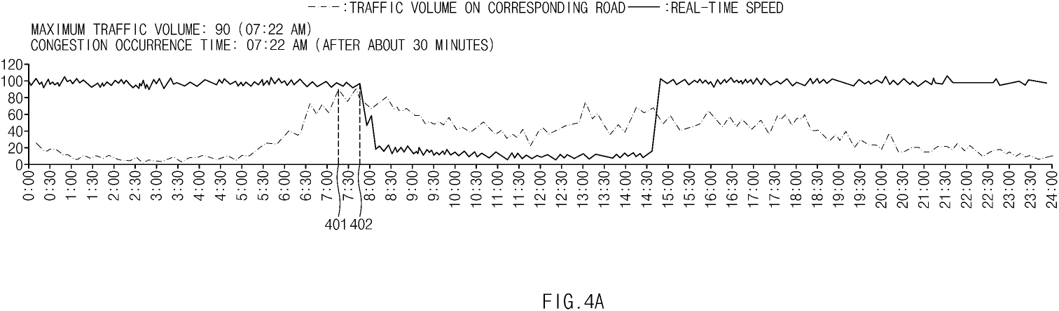

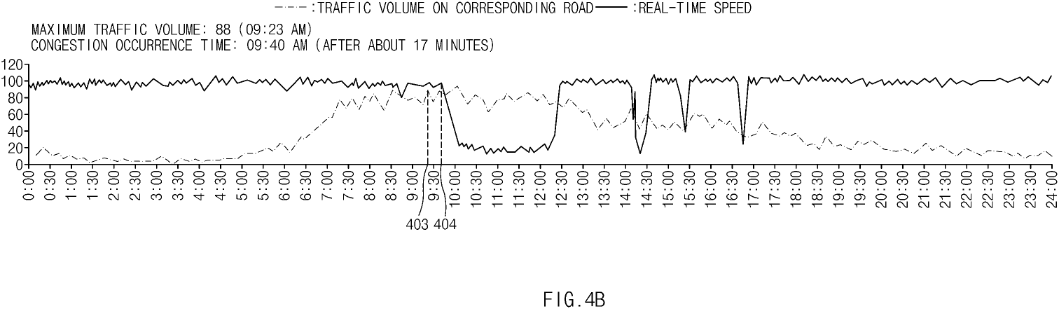

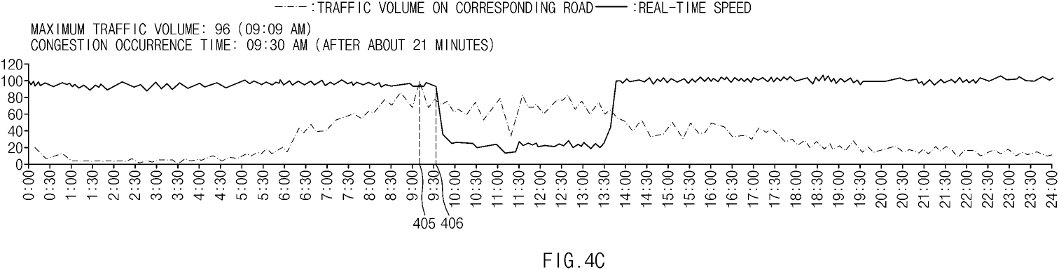

Hereinafter, various embodiments of the present disclosure will be described in detail with reference to FIG. 1, FIG. 2, FIG. 3, FIGS. 4A, 4B and 4C, FIG. 5, FIG. 6, FIG. 7, and FIG. 8. Furthermore, in a description of FIG. 1, FIG. 2, FIG. 3, FIGS. 4A, 4B and 4C, FIG. 5, FIG. 6, FIG. 7, and FIG. 8, an operation described as being performed by an apparatus of predicting a congestion time point may be understood as being performed or controlled by a controller included in the apparatus of predicting the congestion time point.

FIG. 1 illustrates components included in an apparatus 100 for predicting a congestion time point according to an exemplary embodiment of the present disclosure.

Referring to FIG. 1, according to an exemplary embodiment of the present disclosure, the apparatus 100 for predicting the congestion time point may include a plurality of artificial neural networks (ANNs). The apparatus 100 for predicting the congestion time point may control at least one ANN using a processor. For example, the apparatus 100 for predicting the congestion time point may input data to an ANN and may provide a congestion time point prediction function based on a driving situation (e.g., a traffic speed and/or traffic volume) of a vehicle by output data output through various layers included in the ANN.

According to an exemplary embodiment of the present disclosure, the apparatus 100 for predicting the congestion time point may include a first deep learning device 110, a second deep learning device 120, and a congestion time point prediction model 130. Each of the shown components may be a component implemented in an ANN structure including at least one layer (e.g., an input layer, an output layer, and multiple hidden layers arranged between the input layer and the output layer).

For example, the apparatus 100 for predicting the congestion time point may input traffic speed data to the input layer of the first deep learning device 110 and may obtain first output data output to the output layer through the plurality of layers. As an exemplary embodiment of the present disclosure, the traffic speed data may include traffic speed data during a first time in the past.

For example, the apparatus 100 for predicting the congestion time point may input traffic volume data to the input layer of the second deep learning device 120 and may obtain second output data output to the output layer through the plurality of layers. As an exemplary embodiment of the present disclosure, the traffic volume data may include traffic volume data during a second time in the past.

For example, the first time and the second time may be substantially the same time as each other. As an exemplary embodiment of the present disclosure, the first time and the second time may be defined as substantially the same past time zone respect to a time period when input data is input.

For example, the apparatus 100 for predicting the congestion time point may predict the congestion time point by a congestion time point prediction model 130, using at least a portion of the first output data and the second output data.

As an exemplary embodiment of the present disclosure, the apparatus 100 for predicting the congestion time point may perform concatenate calculation of the first output data and the second output data to obtain the determined input data. The apparatus 100 for predicting the congestion time point may input the determined input data to the input layer of the congestion time point prediction model 130 and may predict the congestion time point based on at least a portion of data output to the output layer of the congestion time point prediction model 130 through the plurality of layers.

As an exemplary embodiment of the present disclosure, the apparatus 100 for predicting the congestion time point may input the input data to the congestion time point prediction model 130, may predict a traffic speed from the current time to a specified time in the future based on at least a portion of data output to the output layer of the congestion time point prediction model 130 through the plurality of layers, and may predict the congestion time point using the predicted traffic speed.

As an exemplary embodiment of the present disclosure, the apparatus 100 for predicting the congestion time point may update a weight included in the congestion time point prediction model 130, using the predicted traffic speed. The apparatus 100 for predicting the congestion time point may update a weight of the congestion time point prediction model 130 so that a mean square error (MSE) is reduced.

In an exemplary embodiment of the present disclosure, the apparatus 100 for predicting the congestion time point may identify whether a traffic speed and traffic volume over a time point and/or a time when the traffic speed and the traffic volume are greater than a specified value based on the first output data and the second output data, using the congestion time point prediction model 130, and may predict the congestion time point based on the identified result.

For example, the apparatus 100 for predicting the congestion time point may identify a first time point when a traffic speed decreases to reach a congestion state in a first time and a second time point when a traffic volume reaches a saturation state in a second time. Here, the congestion state is a state in which the traffic speed reaches to a predetermined traffic speed.

For example, the apparatus 100 for predicting the congestion time point may identify a correlation between the first time point and the second time point and may predict the congestion time point based on the identified correlation.

For example, the apparatus 100 for predicting the congestion time point may identify traffic volume on a forward road and traffic volume on a corresponding road, which are included in the second output data. As an exemplary embodiment of the present disclosure, the forward road may include a road with an expected route which is expected that the vehicle will travel. As an exemplary embodiment of the present disclosure, the corresponding road may include a road where the vehicle is currently traveling.

For example, the apparatus 100 for predicting the congestion time point may predict the congestion time point using whether each of the traffic volume on the forward road and the traffic volume on the corresponding road is saturated or is increased or decreased.

For example, the apparatus 100 for predicting the congestion time point may identify a first traffic speed at the first time point when the traffic speed decreases to reach the congestion state in the first time. When the current traffic speed is substantially the same as the first traffic speed and when the current traffic volume on the corresponding road does not reach the saturation state, the apparatus 100 for predicting the congestion time point may predict that congestion will not occur.

For example, the apparatus 100 for predicting the congestion time point may identify first traffic volume at the second time point when the traffic volume on the corresponding road reaches the saturation state in the second time. When it is identified that the current traffic volume is substantially the same as the first traffic volume and will gradually decrease in the future, the apparatus 100 for predicting the congestion time point may predict that congestion will be resolved.

In an exemplary embodiment of the present disclosure, the apparatus 100 for predicting the congestion time point may classify and/or divide and identify data for being input to the congestion time point prediction model 130.

For example, the apparatus 100 for predicting the congestion time point may divide data for predicting the congestion time point (e.g., traffic speed data during the first time, traffic volume data during the second time, the first output data, and/or the second output data) into a train set and a test set. The apparatus 100 for predicting the congestion time point may perform cross validation for the congestion time point prediction model 130 using the train set and the test set.

For example, the apparatus 100 for predicting the congestion time point may divide at least a portion of the train set into a validation set. The apparatus 100 for predicting the congestion time point may determine accuracy using the validation set. The accuracy may include accuracy of the prediction result(s) of the first deep learning device 110, the second deep learning device 120, and/or the congestion time point prediction model 130.

For example, the apparatus 100 for predicting the congestion time point may determine accuracy using the validation set and may perform an early stopping function for a prediction operation in a specified epoch identified that the congestion time point prediction model 130 has accuracy of a predetermined value or more the predetermined value.

In the description of FIG. 1, which is described in detail above, the operation described as being performed by the apparatus 100 for predicting the congestion time point may be understood as being performed by the congestion time point prediction model 130 and/or a controller 40 included in a description of FIG. 2, which will be described below.

FIG. 2 illustrates components included in an apparatus 100 for predicting a congestion time point according to an exemplary embodiment of the present disclosure.

As shown in FIG. 2, the apparatus 100 for predicting the congestion time point according to an exemplary embodiment of the present disclosure may include a storage 10, a communication device 20, an output device 30, and a controller 40. In the instant case, the respective components may be combined into one component and some components may be omitted, depending on a manner which executes the apparatus 100 for predicting the congestion time point according to an exemplary embodiment of the present disclosure.

In an exemplary embodiment of the present disclosure, the storage 10 may store input data to be used for the apparatus 100 for predicting the congestion time point to determine a prediction result and/or result data output by the apparatus 100 for predicting the congestion time point. In the instant case, the input data may include probe data received using the communication device 20 from a probe vehicle. As an exemplary embodiment of the present disclosure, the probe data may include global positioning system (GPS) data, coordinate data, and/or time data. The storage 10 may store various logic, algorithms, and programs required in a process of processing input data and output data to predict a congestion time point.

Such a storage 10 may include at least one type of storage medium, such as a flash memory type memory, a hard disk type memory, a micro type memory, a card type memory (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic RAM (MRAM), a magnetic disk, and an optical disk.

In an exemplary embodiment of the present disclosure, the communication device 20 may be a module which provides a communication interface between the apparatus 100 for predicting the congestion time point and the probe vehicle, which may receive probe data based on a specified period from the probe vehicle. In the instant case, the probe vehicle may have a telematics terminal as a vehicle terminal. The communication device 20 may include at least one of a mobile communication module, a wireless Internet module, or a short-range communication module for communicating with the probe vehicle.

The mobile communication module may communicate with the probe vehicle over a mobile communication network established according to technical standards for mobile communication or a communication scheme (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like), 4th generation (4G) mobile telecommunication, or 5th generation (5G) mobile telecommunication.

The wireless Internet module may be a module for wireless Internet access, which may communicate with the probe vehicle through wireless LAN (WLAN), wireless-fidelity (Wi-Fi), Wi-Fi Direct, digital living network alliance (DLNA), wireless broadband (WiBro), Worldwide Interoperability for Microwave Access (WiMAX), high speed downlink packet access (HSDPA), high speed uplink packet access (HSUPA), long term evolution (LTE), long term evolution-advanced (LTE-A), or the like.

The short-range communication module may support short-range communication using at least one of Bluetooth™, radio frequency identification (RFID), infrared data association (IrDA), ultra wideband (UWB), ZigBee, near field communication (NFC), and wireless universal serial bus (USB) technologies.

The output device 30 may provide a user with traffic information including the congestion time point predicted by the controller 40. For example, the output device 30 may provide the user with congestion time point prediction information predicted that congestion will occur due to an increase in traffic volume or traffic speed when the vehicle passes through a specified section.

The controller 40 may perform the overall control so that respective components may normally perform their own functions. Such a controller 40 may be implemented in a form of hardware, may be implemented in a form of software, or may be implemented in a form of a combination thereof. The controller 40 may be implemented as, but not limited to, a microprocessor.

FIG. 3 is a drawing illustrating a relationship among a real-time speed, a pattern speed, and traffic volume according to an exemplary embodiment of the present disclosure.

According to a graph shown in FIG. 3, it may be identified that a real-time speed, a pattern speed, and traffic volume of a vehicle have a specified relation thereamong in a specific time zone. The pattern speed shown in FIG. 3 may be defined as patterning a speed where the vehicle traveled in the past on the same section.

In an exemplary embodiment of the present disclosure, it may be identified that traffic volume increases rapidly in a time zone of about 04:30 to about 18:00 and that the real-time speed decreases in the same time zone.

In an exemplary embodiment of the present disclosure, it may be identified that there is a tendency in which the pattern speed decreases in a time zone of about 16:30 to about 19:30 and that the real-time speed decreases in the same time zone.

In an exemplary embodiment of the present disclosure, it may be identified that traffic volume decreases gradually in a time zone of about 15:00 to about 18:00 and the real-time speed increases rapidly in the same time zone.

In an exemplary embodiment of the present disclosure, it may be identified that there is a tendency in which the pattern speed increases in the time zone of about 15:00 to about 18:00 and that the real-time speed increases rapidly in the same time zone.

Thus, when putting the above-mentioned pieces of information together, it may be identified that the real-time speed has a specific correlation for each time zone depending on traffic volume as well as the pattern speed of the vehicle in the past. Thus, the apparatus of predicting the congestion time point according to various exemplary embodiments of the present disclosure may more accurately predict the congestion time point of the vehicle by further using traffic volume data.

Hereinafter, in a description of FIG. 4A, FIG. 4B and FIG. 4C, the correlation between the traffic volume and the real-time speed will be described below. The description of each drawing may include a relationship between traffic volume and a real-time speed according to different time zones.

FIG. 4A, FIG. 4B and FIG. 4C are drawings illustrating a relationship between traffic volume and a real-time speed according to an exemplary embodiment of the present disclosure. Referring to FIG. 4A, FIG. 4B and FIG. 4C, a correlation between a time point when a traffic volume has a maximum value and a time point when a traffic speed decreases may be identified.

Referring to FIG. 4A, according to an exemplary embodiment of the present disclosure, the traffic volume may correspond to the maximum value at a first time point 401 (e.g., 07:22 AM), and the traffic speed may start to decrease (or congestion may start) at a second time point 402 (e.g., 07:52 AM).

In an exemplary embodiment of the present disclosure, the first time point 401 and the second time point 402 may have a difference of about 30 minutes. In other words, it may be identified congestion occurs on a corresponding road after about 30 minutes elapse from a time point when the traffic volume enters a saturation state.

Referring to FIG. 4B, according to an exemplary embodiment of the present disclosure, the traffic volume may correspond to the maximum value at a third time point 403 (e.g., 09:23 AM), and the traffic speed may start to decrease (or congestion may start) at a fourth time point 402 (e.g., 09:40 AM).

In an exemplary embodiment of the present disclosure, the third time point 403 and the fourth time point 404 may have a difference of about 17 minutes. In other words, it may be identified congestion occurs on the corresponding road after about 17 minutes elapse from a time point when the traffic volume enters the saturation state.

Referring to FIG. 4C, according to an exemplary embodiment of the present disclosure, the traffic volume may correspond to the maximum value at a fifth time zone 405 (e.g., 09:09 AM), and the traffic speed may start to decrease (or congestion may start) at a sixth time point 406 (e.g., 09:30 AM).

In an exemplary embodiment of the present disclosure, the fifth time point 405 and the sixth time point 406 may have a difference of about 21 minutes. In other words, it may be identified congestion occurs on the corresponding road after about 21 minutes elapse from a time point when the traffic volume enters the saturation state.

According to an exemplary embodiment of the present disclosure, the apparatus of predicting the congestion time point (e.g., the apparatus 100 for predicting the congestion time point in FIG. 1 and FIG. 2) may learn models (e.g., a first deep learning device 110, a second deep learning device 120, and/or a congestion time point prediction model 130 of FIG. 1) for predicting the congestion time point, using the correlation between the traffic volume and the real-time speed, which are described above, and may update a weight included in each model.

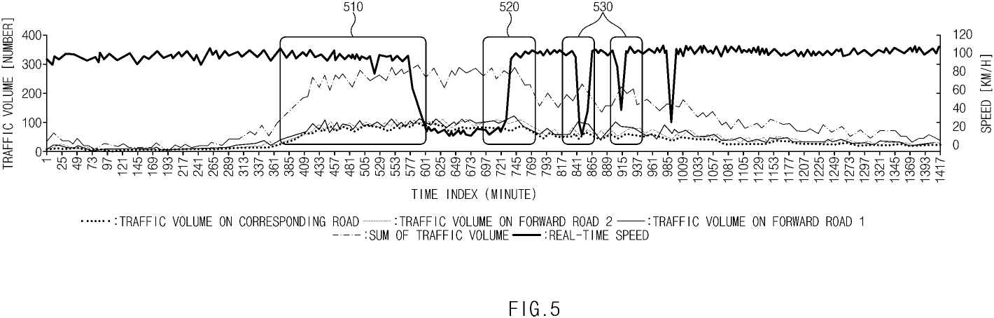

FIG. 5 is a drawing illustrating a relationship between traffic volume and a real-time speed according to an exemplary embodiment of the present disclosure.

Referring to FIG. 5, according to an exemplary embodiment of the present disclosure, an apparatus of predicting a congestion time point (e.g., an apparatus 100 for predicting a congestion time point in FIG. 1 and FIG. 2) may identify traffic volume on a corresponding road, traffic volume on at least one forward road, the sum of traffic volume, and/or a real-time speed in each of time zones and may predict a congestion time point in the future based on the identified result.

In an exemplary embodiment of the present disclosure, referring to reference numeral 510, it may be identified that the real-time speed decreases rapidly at a time point (e.g., 565 minutes) after about one hour from a time point (e.g., 505 minutes) when it is identified that the traffic volume on forward road 1, the traffic volume on forward road 2, and the traffic volume on the corresponding road enter a saturation state. Thus, when the above traffic volume is identified, the apparatus of predicting the congestion time point may identify a correlation where it is able to enter a congestion section as the real-time speed decreases rapidly after about one hour.

In an exemplary embodiment of the present disclosure, referring to reference numeral 520, it may be identified that the real-time speed increases rapidly at a time point (e.g., 720 minutes) adjacent to a time point (e.g., 745 minutes) when it is identified that the traffic volume on forward road 1, the traffic volume on forward road 2, and the traffic volume on the corresponding road are released from the saturation state. Thus, when the saturation state of the traffic volume is released, the apparatus of predicting the congestion time point may identify a correlation where congestion is able to be resolved as the real-time speed increases rapidly at a time point adjacent to the time point when it is identified that the traffic volume is released from the saturation state.

In an exemplary embodiment of the present disclosure, referring to reference numeral 530, it may be identified that the real-time speed decreases rapidly at time points (e.g., 841 minutes and 900 minutes) respectively adjacent to time points (e.g., 850 minutes and 910 minutes) when the traffic volume on forward road 1, the traffic volume on forward road 2, and the traffic volume on the corresponding road increase temporarily. Thus, in the state where the traffic volume increases temporarily, the apparatus of predicting the congestion time point may identify a correlation where congestion is able to occur as the real-time speed decreases temporarily at a time point adjacent to the time point when the traffic volume increases temporarily.

The apparatus of predicting the congestion time point according to an exemplary embodiment of the present disclosure may learn models (e.g., a first deep learning device 110, a second deep learning device 120, and/or a congestion time point prediction model 130 of FIG. 1) for predicting the congestion time point, using the above pieces of data, and may update a weight included in each model.

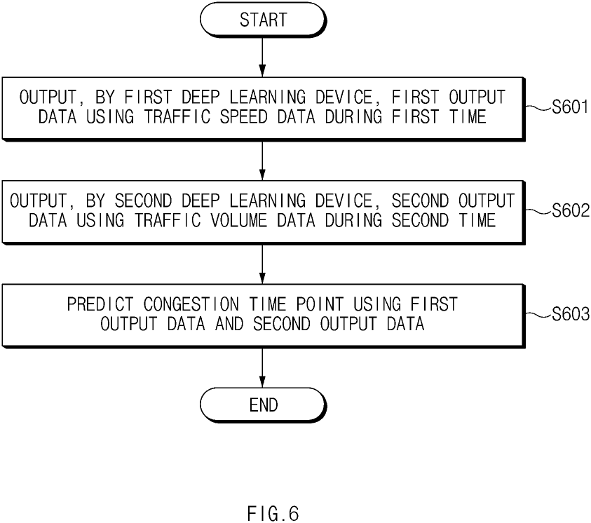

FIG. 6 is an operational flowchart of an apparatus of predicting a congestion time point according to an exemplary embodiment of the present disclosure.

FIG. 6 is a flowchart for describing a method for predicting a congestion time point according to an exemplary embodiment of the present disclosure. Hereinafter, it is assumed that an apparatus 100 for predicting a congestion time point, having components of FIG. 1 and FIG. 2, performs a process of FIG. 6. Furthermore, in a description of FIG. 6, an operation described as being performed by the apparatus of predicting the congestion time point may be understood as being controlled by a controller 40 of the apparatus 100 for predicting the congestion time point in FIG. 1 and FIG. 2.

In S601, the apparatus of predicting the congestion time point may output first output data using traffic speed data during a first time, by a first deep learning device (e.g, a first deep learning device 110 of FIG. 1).

As an exemplary embodiment of the present disclosure, the apparatus of predicting the congestion time point may input the traffic speed data during the first time to an input layer of the first deep learning device and may obtain first output data, output as the input traffic speed data passes through a plurality of layers included in the first deep learning device, through an output layer of the first deep learning device.

In S602, the apparatus of predicting the congestion time point may output second output data using traffic volume data during a second time, by a second deep learning device (e.g., a second deep learning device 120 of FIG. 1).

As an exemplary embodiment of the present disclosure, the apparatus of predicting the congestion time point may input the traffic volume data during the second time to an input layer of the second deep learning device and may obtain the second output data, output as the input traffic volume data passes through a plurality of layers included in the second deep learning device, through an output layer of the second deep learning device.

In S603, the apparatus of predicting the congestion time point may predict the congestion time point using the first output data and the second output data.

As an exemplary embodiment of the present disclosure, the apparatus of predicting the congestion time point may perform concatenate calculation of the first output data and the second output data to obtain the determined input data, may predict a traffic speed up to a specified time in the future by output data output as a result of inputting the obtained input data to a congestion time point prediction model (e.g., a congestion time point prediction model 130 of FIG. 1), and may predict the congestion time point using the predicted traffic speed.

As an exemplary embodiment of the present disclosure, the apparatus of predicting the congestion time point may update a weight included in the congestion time point prediction model so that a mean squared error (MSE) is reduced, using the predicted traffic speed.

As an exemplary embodiment of the present disclosure, the apparatus of predicting the congestion time point may identify a first time point when the traffic speed decreases to reach a congestion state in the first time and a second time point when the traffic volume reaches a saturation state in the second time and may identify a correlation between the first time and the second time, thus predicting the congestion time point based on the identified correction.

As an exemplary embodiment of the present disclosure, the apparatus of predicting the congestion time point may identify traffic volume on a forward road and traffic volume on a corresponding road, which are included in the second output data, and may predict the congestion time point by further using whether each of the identified traffic volume on the forward road and the identified traffic volume on the corresponding road is saturated or is increased or decreased. As an exemplary embodiment of the present disclosure, the forward road may include a road with an expected route which is expected that the vehicle will travel. As an exemplary embodiment of the present disclosure, the corresponding road may include a road where the vehicle is currently traveling.

For example, the apparatus of predicting the congestion time point may identify a first traffic speed at the first time point when the traffic speed decreases to reach the congestion state in the first time. When the current traffic speed is substantially the same as the first traffic speed and when the current traffic volume on the corresponding road does not reach the saturation state, the apparatus of predicting the congestion time point may predict that congestion will not occur.

For example, the apparatus of predicting the congestion time point may identify first traffic volume at the second time point when the traffic volume on the corresponding road reaches the saturation state in the second time. When it is identified that the current traffic volume is substantially the same as the first traffic volume and will gradually decrease in the future, the apparatus of predicting the congestion time point may predict that congestion will be resolved.

As an exemplary embodiment of the present disclosure, the apparatus of predicting the congestion time point may divide the first output data and the second output data into a train set and a test set, may perform cross validation of the congestion time point prediction model using as least some of the divided pieces of data or may determine accuracy of the congestion time point prediction model by use of at least a portion of the train set as a validation set, and may perform an early stopping function in an epoch identified as having accuracy of a predetermined value or more the predetermined value as a result of the performance.

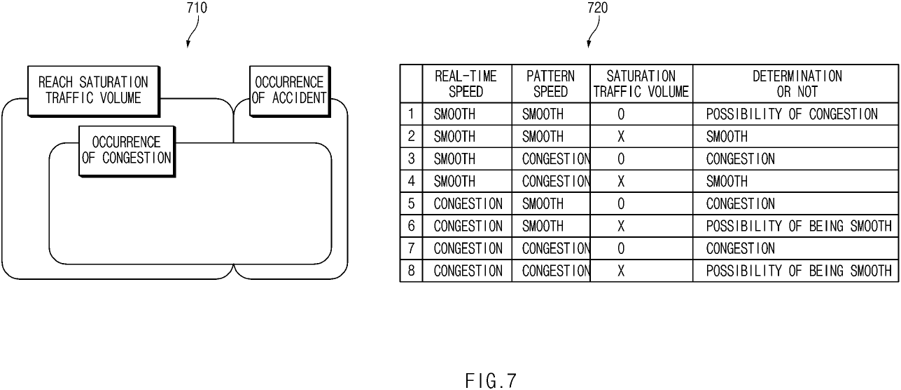

FIG. 7 illustrates an example of a relationship among traffic volume, whether an accident occurs, and congestion occurs and a predicted result of an apparatus of predicting a congestion time point according to an exemplary embodiment of the present disclosure.

Referring to reference numeral 710, according to an exemplary embodiment of the present disclosure, a vehicle may enter a congestion time point which occurs due to various external factors.

For example, when a traffic volume on a corresponding road where the vehicle is traveling reaches a saturation state, congestion may occur. However, although the traffic volume reaches the saturation state, congestion may fail to occur. In the instant case, the apparatus of predicting the congestion time point according to an exemplary embodiment of the present disclosure may predict the congestion time point by further considering other external factors. As an exemplary embodiment of the present disclosure, the apparatus of predicting the congestion time point may more accurately predict the congestion time point by further using traffic speed data and/or whether an accident occurs.

For example, when an accident occurs on a corresponding road where the vehicle is traveling and/or a forward road expected that the vehicle will travel in the future on a movement route of the vehicle, congestion may occur. However, although the accident occurs, in the instant case, the apparatus of predicting the congestion time point according to an exemplary embodiment of the present disclosure may predict the congestion time point by further considering other external factors. As an exemplary embodiment of the present disclosure, the apparatus of predicting the congestion time point may more accurately predict the congestion time point by further using traffic speed data and/or traffic volume data.

Referring to reference numeral 720, according to an exemplary embodiment of the present disclosure, the apparatus of predicting the congestion time point may output a predicted result according to a shown table.

For example, when it is identified that the real-time speed and the pattern speed are in a smooth state and that the traffic volume is in a saturation state, the apparatus of predicting the congestion time point may predict that there is a possibility that congestion will occur during a specified time in the future.

For example, when it is identified that the real-time speed and the pattern speed are in the smooth state and that the traffic volume is not in the saturation state, the apparatus of predicting the congestion time point may predict that the vehicle will smoothly travel without occurrence of congestion.

For example, when it is identified that the real-time speed is in the smooth state, that the pattern speed is in the congestion state, i.e., a state in which the pattern reaches to a predetermined pattern speed, and that the traffic volume is in the saturation state, the apparatus of predicting the congestion time point may predict that congestion will occur.

For example, when it is identified that the real-time speed is in the smooth state, that the pattern speed is in the congestion state, and that the traffic volume is not in the saturation state, the apparatus of predicting the congestion time point may predict that the vehicle will smoothly travel without occurrence of congestion.

For example, when it is identified that the real-time speed is in the congestion state, the pattern speed is in the smooth state, and that the traffic volume is in the saturation state, the apparatus of predicting the congestion time point may predict that congestion will occur.

For example, when it is identified that the real-time speed is in the congestion state, that the pattern speed is in the smooth state, and that the traffic volume is not in the saturation state, the apparatus of predicting the congestion time point may predict that it will enter the smooth state (or the congestion state is resolved) during a specified time in the future.

For example, when it is identified that the real-time speed and the pattern speed are in the congestion state and that the traffic volume is in the saturation state, the apparatus of predicting the congestion time point may predict that congestion will occur.

For example, when it is identified that the real-time speed and the pattern speed are in the congestion state and that the traffic volume is not in the saturation state, the apparatus of predicting the congestion time point may predict that it will enter the smooth state (or the congestion state is resolved) during the specified time in the future.

The above-mentioned predicted results of the apparatus of predicting the congestion time point are illustrative, and embodiments of the present disclosure are not limited thereto. For example, even when the real-time speed, the pattern speed, and saturation traffic volume are shown in the table of FIG. 7, the apparatus of predicting the congestion time point may output other predicted results depending on a difference between traffic volume on the corresponding road and traffic volume on the forward road, a difference between the real-speed time and the pattern speed, whether an accident occurs, or a combination thereof. Furthermore, the parameters for predicting the congestion time point are illustrative. The apparatus of predicting the congestion time point may predict the congestion time point by further using pieces of data associated with various external factors (e.g., weather, a road state, and/or a driving state of the vehicle).

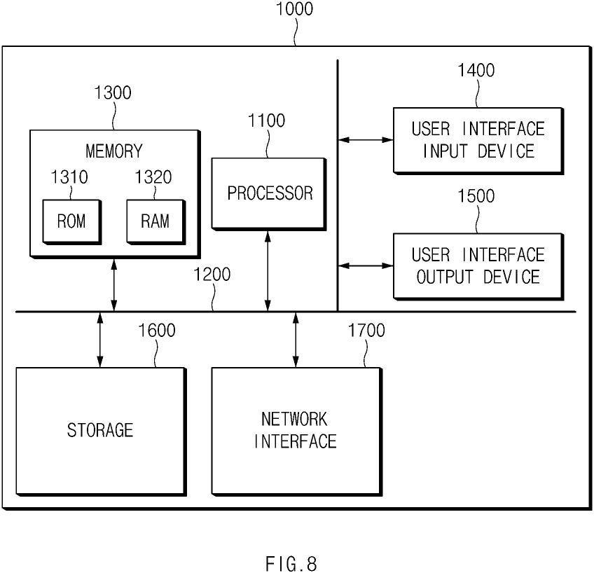

FIG. 8 is a block diagram illustrating a computing system according to an exemplary embodiment of the present disclosure.

Referring to FIG. 8, a computing system 1000 may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Thus, the operations of the method or the algorithm described in connection with the exemplary embodiments included herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

A description will be provided of effects of the apparatus of predicting the congestion time point and the method thereof according to an exemplary embodiment of the present disclosure.

According to at least one of embodiments of the present disclosure, the apparatus and the method thereof may be provided to predict a congestion time point, using traffic volume data and traffic speed data.

Furthermore, according to at least one of embodiments of the present disclosure, the apparatus of predicting the congestion time point and the method thereof may be provided to continuously learn a prediction model using the predicted result and determine the predicted result having higher accuracy.

Furthermore, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of predetermined exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus of predicting a congestion time point, the apparatus comprising:
a first deep learning device configured to output first output data using traffic speed data during a first time;
a second deep learning device configured to output second output data using traffic volume data during a second time; and
a congestion time point prediction model configured to predict the congestion time point using at least a portion of the first output data and the second output data.

2. The apparatus of claim 1, wherein the congestion time point prediction model is configured to obtain input data determined by performing concatenate calculation of the first output data and the second output data and to predict the congestion time point using the input data.

3. The apparatus of claim 2, wherein the congestion time point prediction model is configured to predict a traffic speed up to a specified time in the future using the input data and to predict the congestion time point using the predicted traffic speed.

4. The apparatus of claim 3, wherein the first time and the second time correspond to a same past time.

5. The apparatus of claim 3, wherein the congestion time point prediction model is configured to update a weight included in the congestion time point prediction model so that a mean squared error (MSE) is reduced, using the predicted traffic speed.

6. The apparatus of claim 1, wherein the congestion time point prediction model is configured to identify a first time point when a traffic speed decreases to reach a congestion state in the first time and a second time point when a traffic volume reaches a saturation state in the second time, to identify a correlation between the first time point and the second time point, and to predict the congestion time point using the identified correlation.

7. The apparatus of claim 1, wherein the congestion time point prediction model is configured to identify traffic volume on a forward road and traffic volume on a corresponding road, wherein the traffic volume on the forward road and the traffic volume on the corresponding road are included in the second output data, and to predict the congestion time point by further using whether each of the identified traffic volume on the forward road and the identified traffic volume on the corresponding road is saturated or is increased or decreased.

8. The apparatus of claim 7, wherein the congestion time point prediction model is configured to identify a first traffic speed at a first time point when a traffic speed decreases to reach a congestion state in the first time and configured to predict that congestion will not occur, when a current traffic speed is a same as the first traffic speed and when current traffic volume on the corresponding road does not reach a saturation state.

9. The apparatus of claim 7, wherein the congestion time point prediction model is configured to identify first traffic volume at a second time point when the traffic volume on the corresponding road reaches a saturation state in the second time and configured to predict that congestion will be resolved, when it is identified that current traffic volume is a same as the first traffic volume and will decrease in the future.

10. The apparatus of claim 1, wherein the congestion time point prediction model is configured to divide the first output data and the second output data into a train set and a test set and configured to perform cross validation, using the train set and the test set.

11. The apparatus of claim 10, wherein the congestion time point prediction model is configured to determine accuracy by use of at least a portion of the train set as a validation set and configured to perform an early stopping function in an epoch identified as having accuracy of a predetermined value or more the predetermined value.

12. A method for predicting a congestion time point, the method comprising:
outputting, by a first deep learning device, first output data using traffic speed data during a first time;
outputting, by a second deep learning device, second output data using traffic volume data during a second time; and
predicting, by a congestion time point prediction model, the congestion time point using at least a portion of the first output data and the second output data.

13. The method of claim 12, wherein the predicting of the congestion time point by the congestion time point prediction model includes:
obtaining input data determined by performing concatenate calculation of the first output data and the second output data; and
predicting the congestion time point using the input data.

14. The method of claim 13, wherein the predicting of the congestion time point by the congestion time point prediction model includes:
predicting a traffic speed up to a specified time in the future using the input data; and
predicting the congestion time point using the predicted traffic speed.

15. The method of claim 14, further including:
updating a weight included in the congestion time point prediction model so that a mean squared error (MSE) is reduced, using the predicted traffic speed.

16. The method of claim 12, wherein the predicting of the congestion time point by the congestion time point prediction model includes:
identifying a first time point when a traffic speed decreases to reach a congestion state in the first time and a second time point when a traffic volume reaches a saturation state in the second time;
identifying a correlation between the first time point and the second time point; and
predicting the congestion time point using the identified correlation.

17. The method of claim 12, wherein the predicting of the congestion time point by the congestion time point prediction model includes:
identifying traffic volume on a forward road and traffic volume on a corresponding road, wherein the traffic volume on the forward road and the traffic volume on the corresponding road are included in the second output data; and
predicting the congestion time point by further using whether each of the identified traffic volume on the forward road and the identified traffic volume on the corresponding road is saturated or is increased or decreased.

18. The method of claim 17, wherein the predicting of the congestion time point by the congestion time point prediction model includes:
identifying a first traffic speed at a first time point when a traffic speed decreases to reach a congestion state in the first time; and
predicting that congestion will not occur, when a current traffic speed is a same as the first traffic speed and when current traffic volume on the corresponding road does not reach a saturation state.

19. The method of claim 18, wherein the predicting of the congestion time point by the congestion time point prediction model includes:
identifying first traffic volume at a second time point when the traffic volume on the corresponding road reaches the saturation state in the second time; and
predicting that the congestion will be resolved, when it is identified that current traffic volume is a same as the first traffic volume and will decrease in the future.

20. The method of claim 19, further including:
dividing the first output data and the second output data into a train set and a test set; and
performing cross validation, using the train set and the test set.
